(19) United States
(12) Patent Application Publication
(10) Pub. No.: US 2011/0127887 A1
(43) Pub. Date: Jun. 2, 2011

(54) GENERATOR FOR A BICYCLE

(76) Inventor: Chin-Sung Tsai, Taipei Hsien (TW)

(21) Appl. No.: 12/626,849

(22) Filed: Nov. 27, 2009

(51) Int. Cl. B62J 6/12

(52) U.S. Cl. 310/67 A

(57) ABSTRACT

A generator for a bicycle has a frame, a mounting bracket and a disk. The frame has an axle. The mounting bracket is mounted on the frame and has an open slot and at least one stator mounted in the open slot and each of the at least one stator having a coil mounted around a cylinder. The disk is mounted rotatably on the axle, rotatably engages the open slot and has a center and multiple permanent magnets. The permanent magnets are mounted on the disk, arranged circularly relative to the center and selectively move into the open slot to align the at least one stator so that induced current is generated by rotating the disk in the open slot. The generator generates electricity for electronic devices on the bicycle.

### BACKGROUND OF THE INVENTION

1. Field of the Invention

The present invention relates to a generator, and more particularly to a generator for a bicycle that uses electromagnetic interaction to generate electricity.

2. Description of Related Art

Bicycles are a popular exercising device for aerobic activity and are also an environmentally friendly transport solution.

However, since bicycles use a human power source instead of electricity or fossil fuels, bicycle lamps are generally powered by batteries, thus negating some environmental benefits.

Further, the batteries require replacement and spares should also be carried in case of battery failure.

To overcome the shortcomings, the present invention provides a generator for a bicycle to mitigate or obviate the aforementioned problems.

### SUMMARY OF THE INVENTION

The main objective of the invention is to provide a generator for a bicycle that uses electromagnetic interaction to generate electricity.

A generator for a bicycle in accordance with the present invention has a frame, a mounting bracket and a disk. The frame has an axle. The mounting bracket is mounted on the frame and has an open slot and at least one stator mounted in the open slot and each of the at least one stator having a coil mounted around a cylinder. The disk is mounted rotatably on the axle, rotatably engages the open slot and has a center and multiple permanent magnets. The permanent magnets are mounted on the disk, arranged circularly relative to the center and selectively move into the open slot to align the at least one stator so that induced current is generated by rotating the disk in the open slot. The generator generates electricity for electronic devices on the bicycle. Other objectives, advantages and novel features of the invention will become more apparent from the following detailed description when taken in conjunction with the accompanying drawings.

### BRIEF DESCRIPTION OF THE DRAWINGS

FIG. 1 is a side view in partial section of a generator for a bicycle in accordance with the present invention;

FIG. 2 is a perspective view of a disk of the generator in FIG. 1;

FIG. 3 is an operational perspective view of two generators in FIG. 1 mounted on a bicycle;

FIG. 4 is an enlarged perspective view of the generator in FIG. 3; and

FIG. 5 is an exploded perspective view of the generator in FIG. 4.

### DETAILED DESCRIPTION OF THE PREFERRED EMBODIMENT

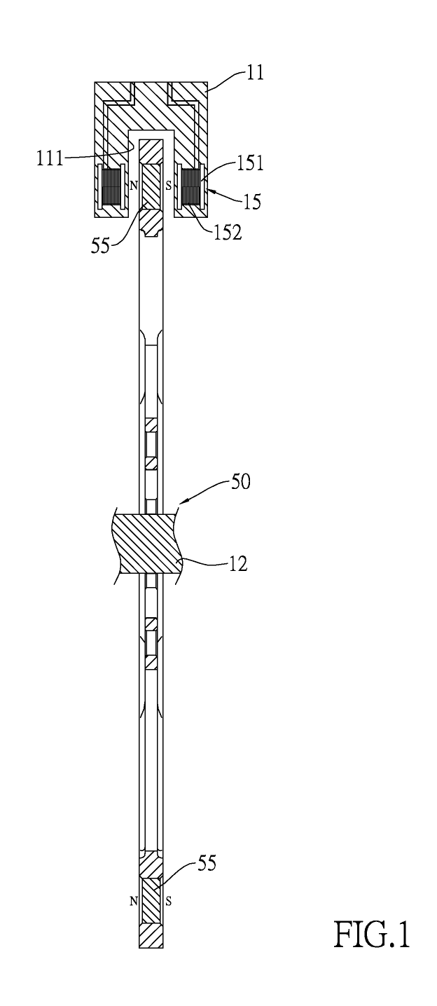

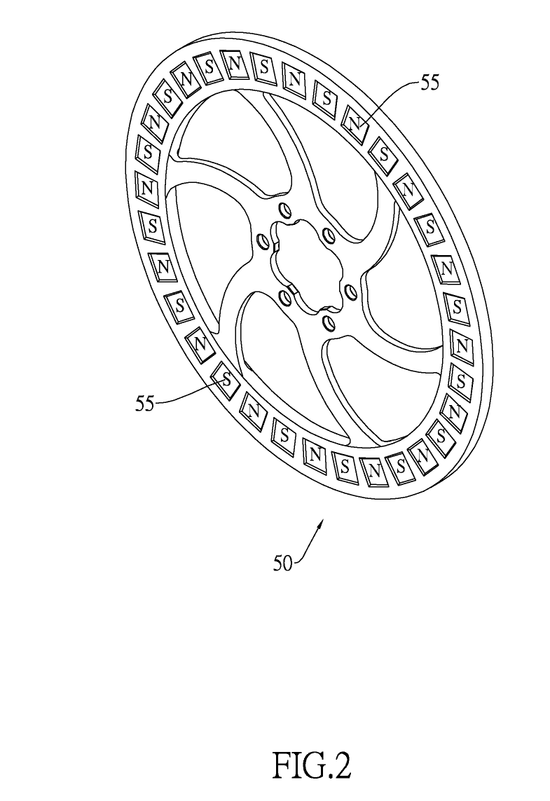

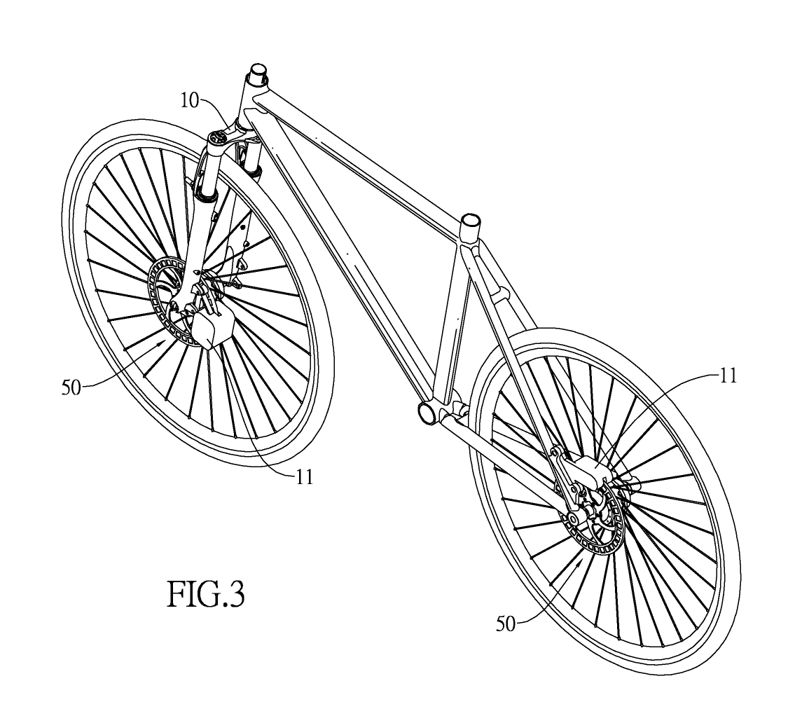

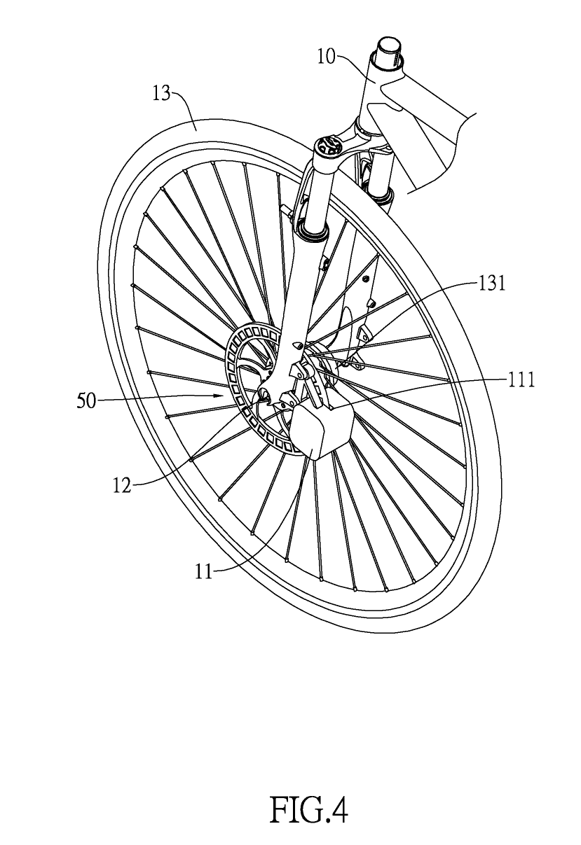

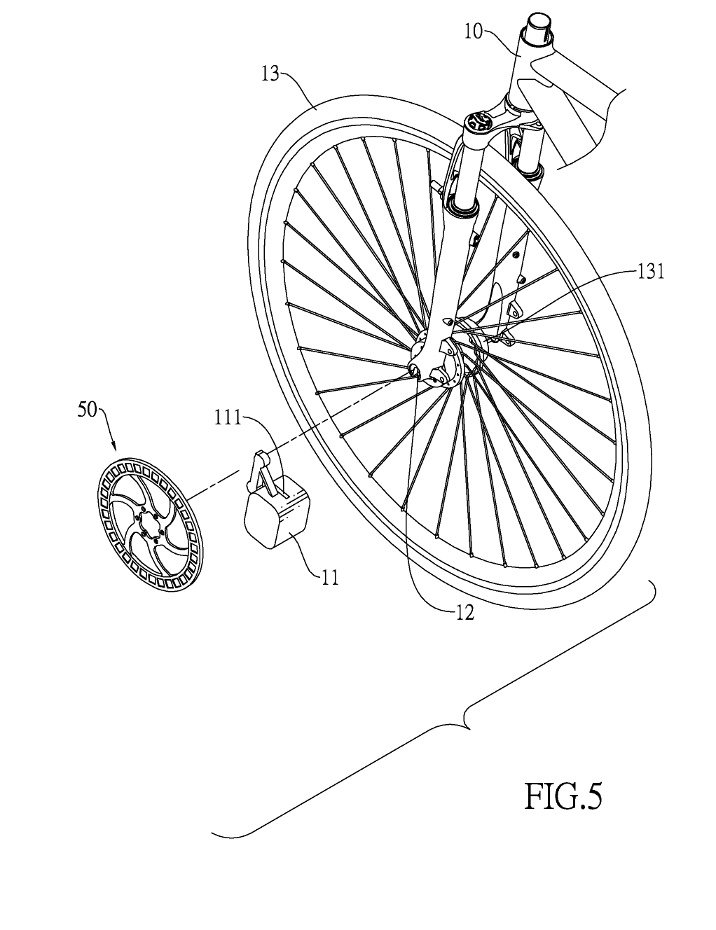

With reference to FIGS. 1 to 5, a generator is mounted on a bicycle and comprises a frame (10), a mounting bracket (11) and a disk (50).

The frame (10) may be a fork, may be a front fork or a rear fork of the aforementioned bicycle. Furthermore, the frame (10) has an axle (12).

The mounting bracket (11) is mounted on the frame and has an open slot (111) and at least one stator (15).

The open slot (111) is defined in the mounting bracket (11) and may have two opposite inner surfaces.

The at least one stator (15) is mounted in the open slot (111) and each of the at least one stator (15) has a cylinder (151) and a coil (152). The cylinder (151) is mounted in the open slot (111). The coil (152) is mounted around the cylinder (151). In a preferred embodiment, two stators (15) are mounted respectively on the inner surface of the open slot (111).

The disk (50) is mounted rotatably on the axle (12), rotatably engages the open slot (111) and has a center and multiple permanent magnets (55).

The permanent magnets (55) are mounted on the disk (50), arranged circularly relative to the center and selectively move into the open slot (111) to align the at least one stator (15) so that induced current is generated by rotating the disk (50) in the open slot (111). Each permanent magnet (55) has a south magnetic pole (S) and a north magnetic pole (N). In a preferred embodiment, adjacent two of the permanent magnets (55) are oppositely aligned so that magnetic fields of the adjacent two permanent magnets (55) are opposite. Each permanent magnet (55) aligns and is located between the two stators (15) when in the open slot (111).

When each permanent magnet (55) passes through the open slot (111), the coil (152) of each stator (15) is effected by the changing intensity of the magnet filed applied thereto so that current is induced in the coil (152). The coil (152) may be connected to an electronic device, such as but not limited to, an LED lamp, a battery or rectifier.

The generator assembled on the bicycles electrifies electronic devices mounted on the bicycles so that riders do not need to replace batteries of the electronic devices.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A generator for a bicycle comprising:
a frame having an axle;
a mounting bracket mounted on the frame and having
an open slot defined in the mounting bracket;
at least one stator mounted in the open slot and each of the at least one stator having
a cylinder mounted in the open slot; and
a coil mounted around the cylinder; and
a disk mounted rotatably on the axle, rotatably engaging the open slot and having a center and multiple permanent magnets mounted on the disk, arranged circularly relative to the center and selectively moving into the open slot to align the at least one stator so that induced current is generated by rotating the disk in the open slot.

2. The generator as claimed in claim 1, wherein
the open slot of the mounting bracket has two opposite inner surfaces;
two stators are mounted respectively on the inner surface of the open slot;
each permanent magnet aligns and is located between the stators when in the open slot.

3. The generator as claimed in claim 1, wherein adjacent two of the permanent magnets are oppositely aligned.

4. The generator as claimed in claim 2, wherein adjacent two of the permanent magnets are oppositely aligned.

5. The generator as claimed in claim 1, wherein the frame is a fork.

6. The generator as claimed in claim 4, wherein the frame is a fork.
